(19) United States
(12) Patent Application Publication
(10) Pub. No.: US 2022/0252414 A1
(43) Pub. Date: Aug. 11, 2022

(54) SYSTEMS AND METHODS FOR NAVIGATION AND LOGISTICS MANAGEMENT

(71) Applicant: Ford Global Technologies, LLC, Dearborn, MI (US)

(72) Inventors: Jeremy Lerner, Southfield, MI (US); Scott Huggins, Novi, MI (US); Taylor Hawley, Oak Park, MI (US)

(73) Assignee: Ford Global Technologies, LLC, Dearborn, MI (US)

(21) Appl. No.: 17/171,013

(22) Filed: Feb. 9, 2021

(51) Int. Cl. G01C 21/34; B60W 10/18

(52) U.S. Cl. CPC G01C 21/3469; G01C 21/3415; B60W 2556/50; B60W 10/18; G01C 21/3446

(57) ABSTRACT

Systems and methods for navigation and logistics management are disclosed herein. An example method can include determining route data for a route traveled by a vehicle. The route data being defined by any one or more of road condition, traffic, fuel consumption, and trip length. Determining vehicle wear and tear data. The vehicle wear and tear data being adjusted based on the route data. Determining a cost of the route based on the route data, the vehicle wear and tear data, and vehicle depreciation. Selecting a remediating action for the vehicle based on the cost of the route. The remediating action when implemented reduces an ownership cost of the vehicle relative to a baseline or expected cost of ownership.

### BACKGROUND

Drivers may be presented with multiple route options that differ only slightly in total travel time but can differ significantly in terms of cost. Other route variabilities include, but are not limited to, driver experience, traffic, trip distance, and so forth. Drivers are typically only provided information about a trip's length (e.g., time), distance, and in some instances fuel consumption.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIGS. 2A-2C collectively illustrate an example true cost routing procedure with a plurality of route options.

FIGS. 3A-3B collectively illustrate another example true cost routing procedure with a plurality of route options and fuel refilling options.

FIG. 4 is a flowchart of example method of the present disclosure.

FIG. 5 is a flowchart of another example method of the present disclosure.

### DETAILED DESCRIPTION

### Overview

The present disclosure is directed to systems and methods for providing navigation and logistics management for vehicles. For example, vehicle ownership information, such as a true and complete cost of ownership, can be determined. In some instances, predicted or modeled vehicle operational costs can be considered when selecting a particular vehicle navigational route.

As noted above, typical systems may only provide information about trip length, distance, and/or fuel usage. The systems and methods described here provide additional information to a true vehicle ownership cost calculation, such as an estimation of vehicle depreciation, vehicle component degradation estimations (such as rotor degradation due to more common braking), fueling station pricing information (can include gas, ethanol and/or electric charging), real-time road data to provide more accurate fuel usage estimations, toll costs, and weather considerations—just to name a few examples. The systems and methods may also take into consideration specific driver behaviors and/or situations. For example, drivers that lease vehicles typically care less about the impact of the route on the vehicle, and more about timing and immediate costs because the cost of ownership is typically borne by the lessor. To be sure, while a lease driver may care about costs such as fuel, tolls, and the like, the driver may not care about some aspects of vehicle costs or vehicle depreciation as an owner/driver may. That is, some costs are experienced by all types of drivers/operators, but some costs are attributable to vehicle costs. Thus, cost of ownership includes both types or genus of cost. Historical data, such as correlations between a specific road segment and damage to the vehicle, may also be taken into account.

It will be understood that there are many known and many hidden costs that can be uncovered when evaluating various routes that a vehicle may take to a destination. For example, drivers may prioritize estimated time of arrival (ETA), but when the cost of a trip (especially a route that is often taken) is known to be high, drivers may consider cheaper and longer routes. Example cost considerations of a route include, but are not limited to, tolls (bridges and tunnels have significantly different tolls than others) and vehicle maintenance (route impact on vehicle's wearable parts, as well as incremented to the standard/expected maintenance). By way of example, an example vehicle traveling 50 miles may have an associated cost of approximately $1.00 if the driver changes the vehicle's oil every 5,000 miles for $50; $1.00=(50/5000)*$50. Also, 50 miles may cost approximately $0.80 if the driver changes their tires every 50,000 miles for $800; $0.80=(50/50,000)*$800. The fuel costs of the vehicle may vary based on the number of wheels, axles, and types of tires, each of which may have a significant impact on fuel usage (driver behavior can also influence fuel consumption). Vehicle depreciation is also another example cost. Collectively, the systems and methods herein can incorporate various cost-affecting parameters into algorithms that allow drivers to make educated route choices.

Further, if any cost information is missing from a portion route, that lack of information can both be used to determine a relative popularity of certain road (if one portion of a road has significantly fewer traversals than other nearby roads, that road was likely deliberately avoided for some reason) and a driver can be notified of the lack of information. For example, if route A has road surface information for the entire route and route B has road surface information for all but five miles of the route, the driver can be informed of the estimated costs of routes A and B using all available information as well as the fact that some of route B has an unknown road surface, which may result in increased cost. These features may encourage drivers to continue using highly used roads and may result in uneven wear on the roads (perhaps no more than typical driving behavior, however). In some instances, a lack of sufficient road quality data can result in a road or route being removed from consideration as a route option. For example, the road quality data may be outdated. In another example, the road quality data may not exist. In another example, the road quality data may be sparse.

If other information is missing, such as real-time traffic, historical information can be used to estimate current conditions. On the other hand, if the information is not substitutable, such as weather information, the driver can be informed of the variables that were included in the route cost estimate. That is, for each route, the cost factors that are included can be presented to the driver (also enabling the driver to toggle them more easily). This may allow the driver to better identify situations when some cost-affecting factors cannot be determined. For example, an analysis of route A includes estimated fuel cost, vehicle depreciation, a likelihood of vehicle collision, and tolls, and route B includes all the same plus road surface conditions. The driver can be informed that both route costs use fuel cost, vehicle depreciation, the likelihood of vehicle collision, and tolls, but route A does not include the potential cost due to road surface conditions, while route B does include that cost. The driver could also be informed of a best-case and a worst-case estimate for the cost due to road surface conditions on route A. That is, the driver could be provided an estimated cost incurred due to a low-quality road surface and a high-quality road surface so they can better compare the cost of route A with route B. It will be understood that toll costs may differ for different types of vehicles. For example, some toll lanes have reduced fees for electric vehicles, whereas a large and heavy truck may incur a higher bridge toll than a small sedan.

Connectivity cost to an OEM (or vehicle owners, if cellular data costs are incurred by vehicle owners) can also be estimated, or at least minimized, along certain routes. That is, routes that include large portions of poor cellular signal reception may end up incurring a larger cellular transmission cost due to potential roaming or excessively failing to transmit data being sent during periods of poor connectivity. The cellular connectivity cost can also be included in routing through two main factors. Firstly, the longer the route, the longer the vehicle remains connected to a cellular signal, which will incur a cost for connected vehicles sending data. Secondly, if there are portions of the route with a poor cellular signal, the data sent by the vehicle in those areas may need to be sent more than once to ensure it is properly received by the remote server. Both of these factors will incur a cost to an OEM and/or to the vehicle driver.

In addition to cellular connectivity, Wi-Fi connectivity provides even cheaper data off-loading. Routes may have projections of data volume (MBs) and cost per unit ($/MB) projections for offloading data along the associated route. Furthermore, certain advanced driver assistance system (ADAS) features, such as park assist features in valet situations, require that routes support connectivity during the entire route, the unattended remote operation may be configured to be canceled at any time. For this true cost routing application, the cost of the route would be prohibitively high on routes that are missing connectivity and thus would not be route candidates.

In some instances, a true total cost of ownership estimation or analysis can be used to automatically adjust vehicle parameters. For example, if it is determined that a driver is contributing to the excess cost of ownership expense by their driving behaviors, an equipped vehicle can automatically adjust various vehicle parameters such as limiting vehicle acceleration when the driver is known to accelerate too quickly which results in excess fuel costs and engine wear. Of course, certain limitations on adjusting vehicle parameters can be implemented. For example, ADAS sensors may determine that a vehicle operation is appropriate such as when a driver is accelerating to avoid a collision or to merge onto a highway.

In another example, the vehicle can adjust braking response when the driver is known to excessively apply the brakes of the vehicle. Such excess braking can increase wear and tear on the braking system. The vehicle could automatically slow the vehicle when approaching a stoplight or stop sign, for example, rather than allowing the driver to wait until the vehicle is too close to its intended stopping point. In some instances, a vehicle owner can select a cost of ownership or operation threshold. The vehicle can automatically adjust any combination of vehicle functionalities to ensure that the vehicle is operated within the cost of ownership threshold.

Some example systems and methods can combine past route data to project future behaviors onto a different vehicle or set of vehicles to obtain an accurate projected true total cost of ownership for the different vehicle or set of vehicles. An example true cost of ownership may be based on a number of factors, including location and routing history, driving style, current gas prices (and/or historical trends), vehicle-specific part costs, mechanic rates, required vehicle inspections, and/or HVAC usage—just to name a few. The location and routing history may include information such as the quality of roads being driven on, length of trips, or any other types of information. Factors such as the percentage of time on the highway versus surface streets and waiting times experienced at traffic lights can provide an estimate of fuel usage. The effects of road surfaces on vehicle maintenance can also be included in the cost estimate. The driving style may include information such as harsh braking patterns, fast acceleration, and so forth.

### Illustrative Embodiments

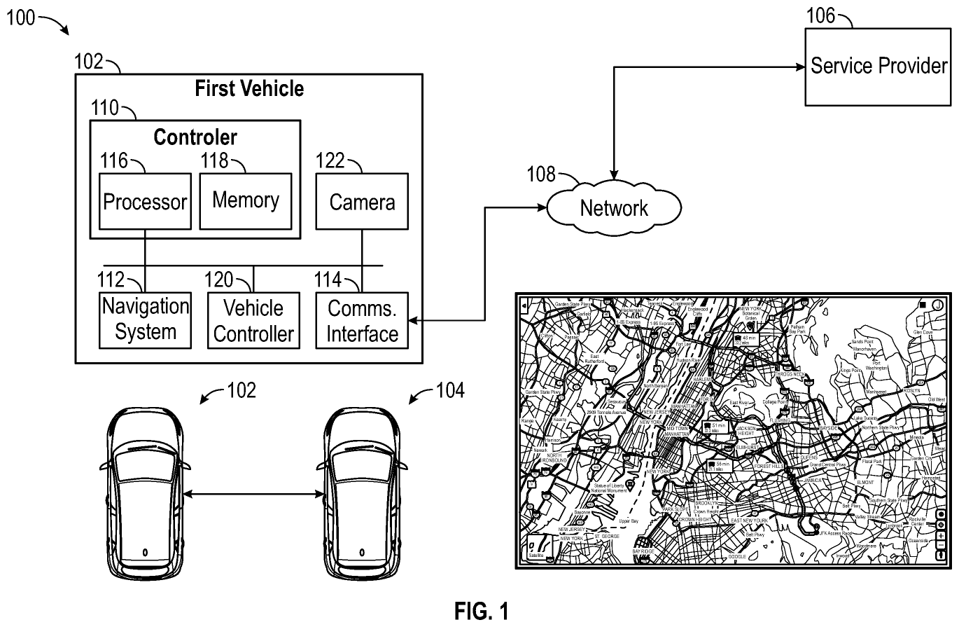

Turning now to the drawings, FIG. 1 depicts an illustrative architecture 100 in which techniques and structures of the present disclosure may be implemented. The architecture 100 can include a first vehicle 102, a second vehicle 104, a service provider 106, and a network 108. Additional or fewer vehicles can be included in some instances. Some or all of these components in the architecture 100 can communicate with one another using the network 108. The network 108 can include combinations of networks that enable the components in the architecture 100 to communicate with one another. The network 108 may include any one or a combination of multiple different types of networks, such as cable networks, the Internet, wireless networks, and other private and/or public networks. In some instances, the network 108 may include cellular, Wi-Fi, or Wi-Fi direct.

In general, each of the vehicles disclosed herein can include a connected vehicle. For purposes of brevity, the first vehicle will be described in detail. However, it will be understood that the second vehicle 104 can be similarly configured as the first vehicle 102 is configured. The first vehicle 102 can comprise a controller 110, a navigation system 112, and a communications interface 114. The controller 110 can comprise a processor 116 and memory 118. The processor 116 executes instructions stored in memory 118 to perform any of the route cost analyses and vehicle automation features disclosed herein. The navigation system 112 is generally configured to provide vehicle routing calculations in accordance with the present disclosure. In one example, the controller 110 can be configured to determine route cost of a plurality of routes from the first vehicle's current location to a destination.

The controller 110 can be configured to communicate with a vehicle controller 120 that provides or controls one or more vehicle functions. The vehicle controller 120 could be configured to select driving modes or other vehicle parameters based on signals from the controller 110. The controller 110 can be configured to determine route cost and cause the vehicle controller 120 to selectively adjust one or more vehicle operating parameters or modes based on the determined route cost. Detailed example use cases are provided herein. A vehicle operating parameter can include a vehicle mode (comfort, sport, economy, etc.). Another vehicle operating parameter can include a throttle or braking response. It will be understood that the controller 110 and the vehicle controller 120 can be integrated. Moreover, any suitable processing element in the first vehicle 102 could be programmed with the functionality of the controller 110. For example, a processor associated with the navigation system 112 could be programmed to perform the operations of the controller 110 disclosed herein.

It will be understood that the methods disclosed herein can be executed entirely at the vehicle level. In other instances, the methods disclosed herein can be executed entirely at the service provider level, or cooperatively between the first vehicle 102 and the service provider 106. For example, the controller 110 of the first vehicle 102 can be configured to collect vehicle data that is transmitted to the service provider 106. The service provider 106 can analyze these data in view of other data such as traffic data, historical road data, and other information and transmit route cost or true cost of ownership calculations to the first vehicle 102. Examples of analyzed data and corresponding output are provided herein in various use cases.

It will be understood that various vehicle parameters may impact a true cost routing. For example, each vehicle, or class of vehicle, may have specific costs attributable to suspension wear, tire wear, brake usage, corrosion susceptibility and wear, and the like. These may be collectively referred to herein as wear and tear costs. Further, in addition to costs attributable to parts or components, cost related to the behavior of the driver can impact wear and tear, and ultimately vehicle ownership cost. For example, drivers that rely heavily on braking can cause excess wear to brakes and tire tread. Drivers that speed may have negative effects on fuel consumption and tire life. Again, these examples are provided for context and are not intended to be limiting.

In more detail, suspension wear and tear can be determined by collecting data from the first vehicle 102, as well as from other vehicles and/or from crowdsource databases. The methods disclosed herein can include an aggregate of data for many vehicles. The vehicle data that may be evaluated can include vehicle data for similar vehicles to the first vehicle 102 (e.g., similar style, make, model, year, and so forth), or aggregated vehicle data without respect to the vehicle type, brand, or model.

In some instances, road conditions can be determined using vision-based detection, such as a camera 122 located on the first vehicle 102 or another vehicle operating in close proximity to the first vehicle 102. The controller 110 can also directly or indirectly measure the travel of shocks or springs in the suspension system by receiving signals from vehicle systems that track and measure such data. Other factors that may be indicative of suspension wear include, but are not limited to, tire slip, ride height suspension status, and the like. Each of these types of data can be obtained from various vehicle sub-assemblies or systems as determined directly by the controller 110 or from the vehicle controller 120.

Histories of suspension repairs for vehicles can be correlated to road types. For example, if many vehicles require suspension repair after traveling on the same road, that road may be identified as likely to cause suspension damage that may require repairs. Such data can be stored at the service provider 106 and received by connected vehicles over the network 108. In other examples, rough roads in urban and rural areas may be due to poor quality pavement, potholes, gravel, and dirt—just to name a few. Again, these data can be assessed at either the vehicle or service provider level and made available to other connected vehicles upon request.

Each vehicle component and excess wear may be determined as a function of a nominal or baseline value. That is, a known or expected service life of a vehicle component under ideal conditions may be known to the original equipment manufacturer (OEM). The controller 110 can calculate excess wear on a per-component basis. For example, a strut of a vehicle operating on rough roads may have its expected service life reduced to 80% compared with a strut under ideal conditions such as smooth roads. Thus, if a prototypical strut would last 50,000 miles when operated on smooth roads, the same strut operating over rough roads may have a life of only 40,000 miles. On rough roads or terrain, control arms may have a life that is reduced to 70%, tie rods may have a life that is reduced to 70%, ball joints may have a life that is reduced to 80%, and trailing arm bushings may have a life that is reduced to 80% —just to name a few (each being compared to an expected life when operated on smooth roads).

Another example relates to tire wear. An example or average tire lasts about 50,000 miles on average roads which is reasonably maintained. Roads with more potholes or uneven surfaces may decrease the life of the tires. Tire pressure monitor sensor data can be determined by connected vehicles and used to determine when tires may need to be replaced. Thus, road usage can be correlated to tire repair and replacement to determine which roads cause more tire wear. Further, different road surface types may have different friction values and may wear tires differently.

Brake usage can also affect vehicle ownership costs. For example, certain types of driving can be correlated to brake pad wear based on brake pad wear sensors and vehicle repair history. In another example, certain traffic situations may tend to cause certain braking profiles (an aggregation of their braking events, which can include the number of times certain ranges of pressure applied to brake pedals, the number of harsh braking events, and so forth) which may cause more wear on the brake pedals. The history of brake pad replacement and brake pad wear sensors can be used to predict brake pad wear based on traffic density.

Corrosion wear can be determined from various factors as well. For example, unpaved roads accelerate corrosion due to caked dirt collecting moisture. The operation of the vehicle on unpaved roads can be determined from map data. For example, map data can be obtained for use by the navigation system 112.

Flying rocks may damage the undercarriage causing premature rust and driving in snowy climates can result in damage due to salt and sand exposure. Note that the damage from the salt may be similar for various routes (or at least hard to determine differences between roads), but some damage due to accelerated rusting can be quantified. By way of example, a city such as Denver uses gravel or sand instead of salt to enhance tire grip when snow is on the ground. This represents different potential damages than salt, which can be quantified based on crowdsourced vehicle data and repair information. Roads with small rocks (i.e., gravel) may represent a higher risk for windshield damage and necessary repair. The number of vehicles that drive over a road with rocks on it that later require windshield repair over the total number of vehicles could be an estimate for the total wear caused by that road segment. In one example, the controller 110 can calculate a vehicle's percent chance of quantifiable damage as a number of vehicle and window repairs required, divided by a total number of vehicles traveling over the same road or section of road. It will be understood that an overall cost calculation for a route can include a summation of these probabilities over all (or in some instances) a portion of the road segments of a trip, on a per vehicle basis.

It will be understood that the process or method for determining a true operating cost of a vehicle may vary according to vehicle and/or driver parameters. In some instances, the true operating cost can be calculated on an individual route basis. In other instances, the true cost can be an estimation of vehicle costs based on historical driving data for a particular driver and their vehicle. In one example, a broad example of an equation for estimating the true cost for operating a vehicle can include the cost of fuel consumed, plus any tolls paid, plus any vehicle depreciation based on miles driven (e.g., vehicle value at the end of a trip subtracted from the vehicle value at the beginning of the trip), plus a sum of the cost of the wearable parts of the vehicle. That is, for each wearable part, a value can be calculated as a fraction of the total wear that requires a repair (and its associated repair cost) In the alternative, vehicle part wear can be calculated by dividing trip miles by total miles driven until a repair is needed, for any vehicle part that may wear evenly over a set number of miles. For example, oil changes technically can be more fine-tuned or planned than mileage. Most driver have their oil changed every 5,000 (or so) miles. Thus, the cost of a trip (towards the next oil change) may include the distance divided by the miles remaining until an oil change is indicated. This fraction could be more complicated for parts such as brakes and tire wear, which wear differently depending on the road type, traffic density, and so forth. The denominator can be estimated based on crowdsourced vehicle data (correlating driving on different combinations of different types of roads with completed vehicle repairs) and the numerator can be an estimate based on the length of the route and the types of roads. For vehicles still under warranty, a vehicle OEM can better understand and predict vehicle damage based on certain roads and routes. Further, these data allow drivers to be directed to similar routes that are not likely to incur damage and warranty costs. Thus, the controller 110 can cause the navigation system 112 to display alternate routes that reduce vehicle wear and cost.

In some instances, the likelihood of a collision event can be calculated as a number of vehicles involved in collisions divided by the number of vehicles on the road in similar conditions (can be found in crowdsourced or historical data), this value may then be multiplied by an average repair cost (or, instead, using the weighted sum of the actual cost for the repairs, if known). Again, these values may vary and depend on road type, traffic conditions, weather, and so forth.

As noted above, other cost factors for a route that can be determined by the controller 110 can include the cost of cellular or WiFi services that are available along a given route. These data can be obtained by the controller 110 over the network 108 from a database or the service provider 106. For example, the controller 110 can determine available services from coverage maps of cellular providers.

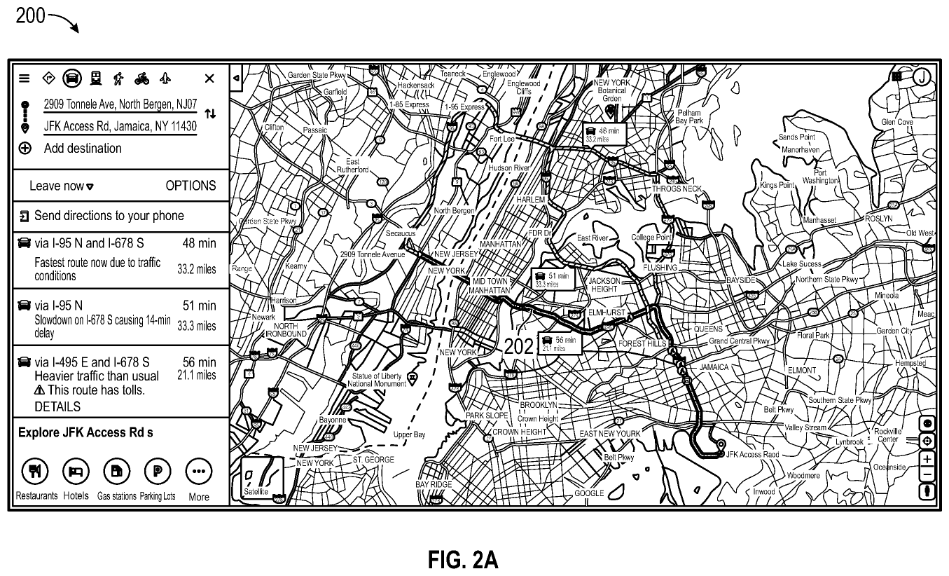

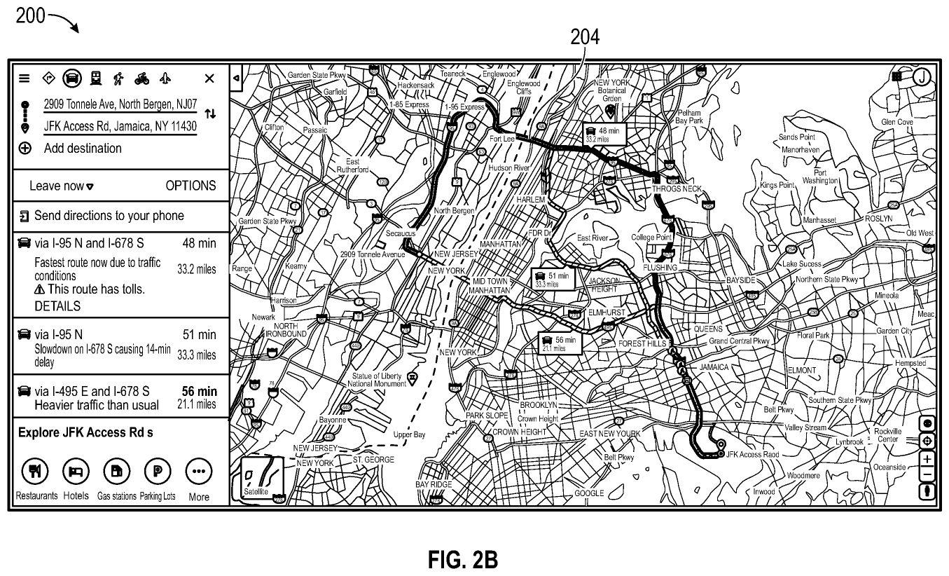

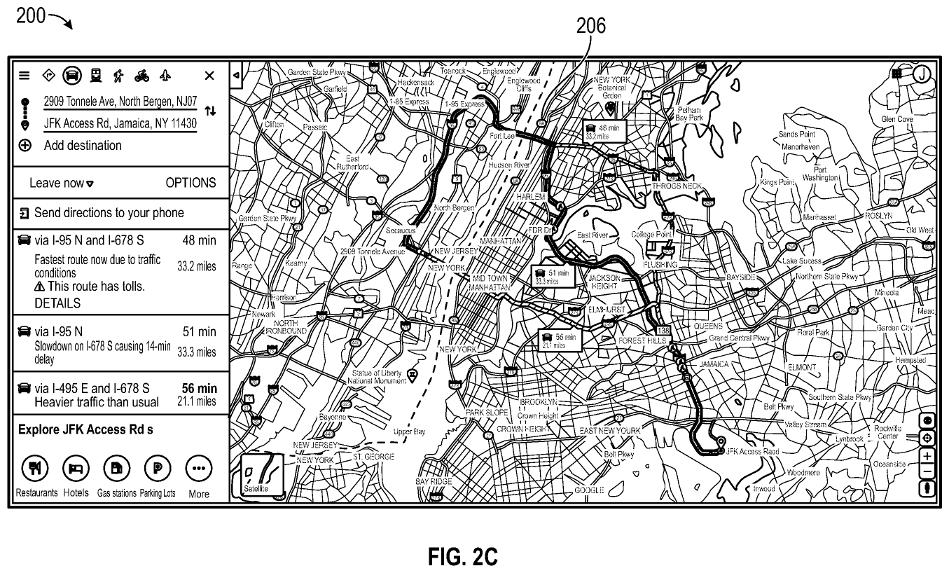

FIGS. 2A-2C collectively illustrate an example use case for cost routing using the true vehicle cost methods disclosed above. Each of the routes in FIGS. 2A-2C are calculated for a driver who desires to travel from New Jersey to JFK Airport and wants to understand the cost represented by each route. FIG. 2A illustrates an example graphical user interface 200 displaying an example route 202 that is considered to be the cheapest and slowest route. To be sure, the graphical user interface 200 can be displayed on a navigation system of a vehicle (such as the navigation system 112 of FIG. 1).

Other ancillary cost considerations for this route include high brake pad wear and medium suspension/tire wear. The selected route cost details may include $3.00 for vehicle depreciation (mileage), $0.35 incremented to the next oil change ($50 every 5,000 miles), $0.80 incremented to the next brake pad repair (traffic and many intersections), $0.80 incremented to the next tire or suspension repair, $5.68 gas cost (including idling), and $8.00 for toll cost, for a total estimated cost of $18.63 and a total estimated time of 56 minutes.

FIG. 2B illustrates the graphical user interface 200 that displays another example route 204 that is considered to be the fastest and most expensive route. Other ancillary cost considerations for this route include low brake pad wear (not stopping as quickly by being on a highway), additional miles added to depreciation, and high costs added due to increases in suspension use and tire wear. The selected route cost details may include $4.00 for vehicle depreciation (mileage), $0.45 incremented to the next oil change ($50 every 5,000 miles), $0.30 incremented to the next brake pad repair (traffic and many intersections), $1.50 incremented to the next tire or suspension repair, $3.74 gas cost (including idling), and $20.00 toll cost, for a total estimated cost of $29.99 and a total estimated time of 48 minutes.

FIG. 2C illustrates the graphical user interface 200 providing another example route 206 that is considered to be a middle ground route having a medium cost and medium route time, along with other cost considerations such as low brake pad wear, more miles put on the odometer (compared to other example routes), along with low suspension and tire wear.

An example calculation of true operational cost for the vehicle may include the following variables: $4.00 for vehicle depreciation (mileage), $0.45 incremented to the next oil change ($50 every 5,000 miles), $0.30 incremented to the next brake pad repair (traffic and many intersections), $0.25 incremented to the next tire or suspension repair, $3.79 for gas cost (including idling), and $15 toll cost, with a total estimated cost of $23.79 and a total estimated time or 51 minutes. Using these examples, the driver can be presented options through the navigation system 112.

The driver can select their most preferred option that each includes a more accurate cost representation relative to processes that only consider factors such as total time, distance, and optionally tolls. Each route and true cost data pertaining to the route can be displayed using a graphical user interface, such as those illustrated in FIGS. 2A-2C. The driver can select the fastest route if time is of the essence. The driver can choose the least wear on the vehicle the driver prefers to minimize part wear, and the cheapest route if time is not a concern.

As noted above, when the vehicle is configured with a controller for automated responses, the controller can be configured to automatically select a route that is most likely to result in a lower vehicle operational cost than other alternate routes. Referring to FIGS. 1-2C collectively, the controller 110 can be configured to implement automatic vehicle control features that may automatically select one route from a plurality of routes based on a driver chosen subset of the true vehicle cost parameters. For example, an owner of the first vehicle 102 can configure the controller 110 through programming or a vehicle-based interface to choose routes that result in the lowest possible cost of ownership and operation. The driver may program the controller 110 through a user interface provided on a vehicle display, through voice activation, or through use of a mobile application on a Smartphone—just to name a few.

Using the examples above, the controller 110 can be configured to automatically select the route 206 of FIG. 2C, even when other routes are available. In some instances, this automatic section may be based on a cost of ownership or operation threshold. For example, an owner of a vehicle can specify maximum wear and tear value(s) for any given vehicle component or set of components. Any route suggested to a driver may comply with these maximum wear and tear value(s). For example, the cost of ownership or operation threshold could include a limitation on how much suspension, tire, or engine wear may be allowed, or another set of criteria of vehicle operation. The cost of ownership or operation threshold can be applied to at least one element of the vehicle wear and tear data, such as tire wear for example. For example, the driver could also choose to minimize fuel and toll costs while entirely disregarding costs related to wear and tear that may impact the vehicle in the long term (after the lease ends). Additionally or alternatively, they could include wear and tear costs that may impact the vehicle in the short term (prior to the lease ending).

When a remediating action is taken, the remediating action may be enacted to reduce an ownership cost of the vehicle relative to an example cost of ownership or operation threshold. For example, a known or baseline service life and fuel economy may be known for most, if not all, vehicles. An expected cost of ownership can be generated for a vehicle that is essentially a best-case scenario or ideal the vehicle. Using empirical data as disclosed herein, the true cost of ownership or operation can be determined as compared to this expected cost of ownership, providing owners with realistic and customized expectations for the vehicle. Moreover, various remediation actions implemented in accordance with the present disclosure may reduce the true cost of ownership or operation compared to situations where the driver does not implement remediating measures. Stated in another way, the remediating action, when implemented, reduces an ownership cost of the vehicle compared to if the remediation action was not taken. For example, if it is determined that the vehicle should be set in an economy mode rather than sport mode, this type of remediation action would reduce the operating cost of the vehicle by reducing fuel consumption. Another example includes choosing one route over another to minimize vehicle wear and tear and therefore the overall cost due to vehicle wear and tear.

The controller 110 can be configured to track and analyze driver behavior for the first vehicle 102. The controller 110 (or service provider 106) can analyze the driver behaviors such as acceleration, braking, steering, preferred routes, and so forth. The controller 110 may utilize these data to selectively adjust one or more vehicle parameters based on a desired cost of operation for the vehicle. If the controller 110 has been configured to minimize vehicle wear and tear, the controller 110 may cause the vehicle controller 120 to select an economy or comfort mode of operation for the first vehicle 102. Enacting an economy or comfort mode of operation may limit acceleration or overall vehicle speed, which reduces fuel consumption and engine wear.

Alternatively, the controller 110 could block sport or performance modes. In yet another example, when the driver's behaviors indicate that the driver is likely to accelerate excessively, the controller 110 can cause the vehicle controller 120 to damp throttle responses. In another example, the controller 110 may prevent the navigation system 112 from providing route options that are longer than a shortest calculated route in order to prevent excess mileage. In other words, the controller 110 would only prioritize route length in terms of distance in determining the lowest cost. The controller 110 may prevent the navigation system 112 from providing route options that involve bumpy or unpaved roads. Thus, aspects of vehicle wear and tear can be correlated to road quality of the various roads driven by the vehicle.

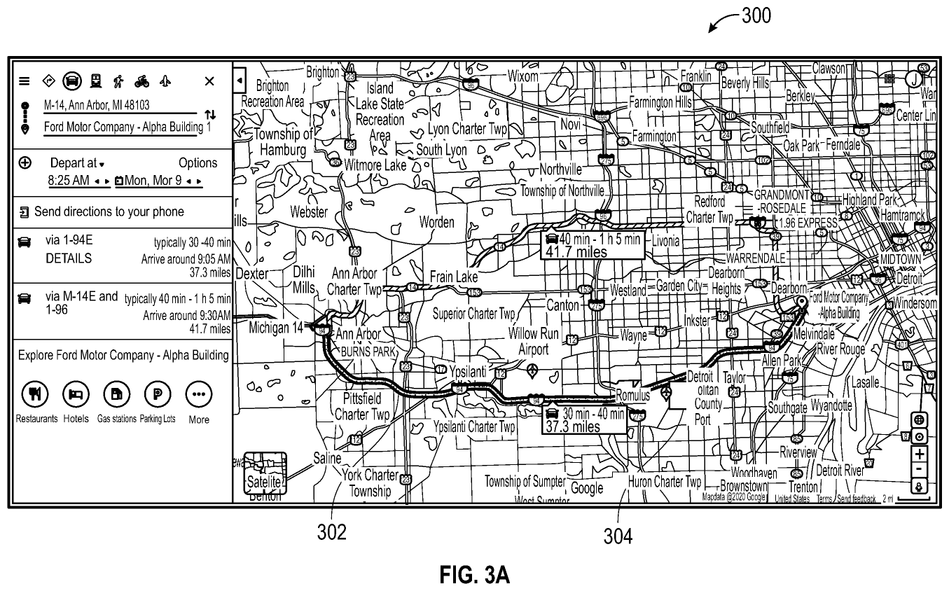

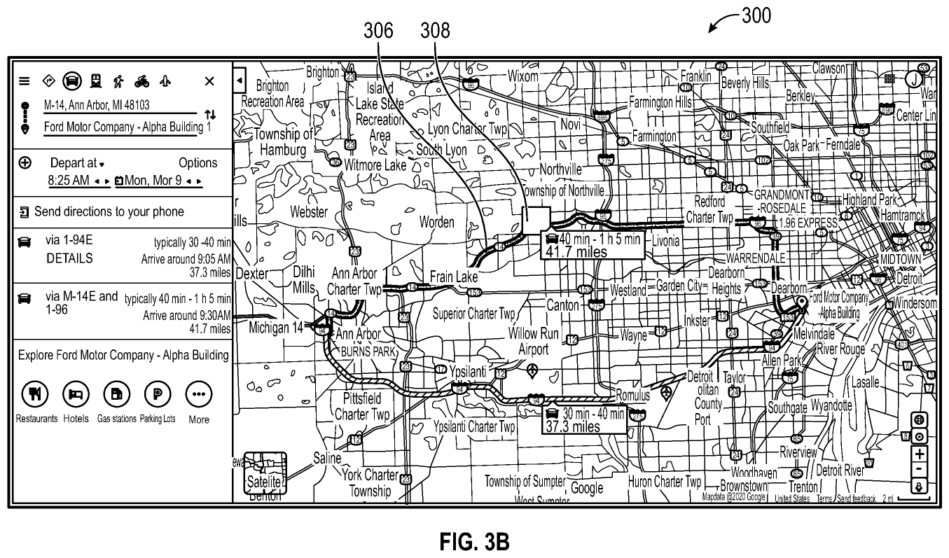

FIGS. 3A-3B collectively illustrates a graphical user interface 300 that illustrates route options considering vehicle operating costs such as fuel consumption and fuel prices. Route 302 involves traveling from a departure point to a destination point without filling the vehicle with fuel. This route minimizes the cost not including the gas fill up, but may ultimately lead to a higher cost paid by the driver, despite the shorter trip time. The cost associated with this route is $12.75. A gas station 304 on this route 302 provides gas at $3.00 per gallon.

The total cost of this trip/route includes $2.90 for vehicle depreciation (mileage), $0.85 incremented to the next oil change ($50 every 5,000 miles), $1.00 incremented to the next brake pad repair (traffic and many intersections), $1.00 incremented to the next tire or suspension repair, $7.00 for gas cost (including idling), $30.00 gas fill up ($3.00 per gallon, 10 gallons), for a total estimated cost of $42.75 and a total trip time of 30-40 minutes.

Route 306 includes a gas station 308 with a cost of $2.00 per gallon. The cost of this route without filling up with fuel is $12.90. Even though this route is more expensive without the gas cost, it minimizes the cost including filling up the gas tank, which may also reduce the cost of future trips.

The total cost of this trip/route includes $3.00 for vehicle depreciation (mileage), $0.90 incremented to the next oil change ($50 every 5,000 miles), $1.00 incremented to the next brake pad repair (traffic and many intersections), $1.00 incremented to the next tire or suspension repair, $7.00 gas cost (including idling), $20.00 for gas fill up ($2.00 per gallon, 10 gallons), for a total estimated cost of $32.90 and a total trip time of 40-75 minutes.

As noted above, driver behaviors (either a single driver of interest or an aggregation of data from a plurality of drivers) can be used to control vehicle cost of ownership and/or vehicle behaviors. For example, a driver's historical trips can be re-simulated with a newer vehicle and new environmental costs in order to most accurately determine the true total cost of ownership (sum of the costs for each trip). For example, the driver of the first vehicle 102 may be interested in driving or buying the second vehicle 104. It is assumed that the first vehicle 102 and the second vehicle 104 have at least one difference relative to one another such that their true calculated cost of ownership may be different for the same driver.

In general, the route history for a driver in a particular vehicle can be used to quantify future route costing for a current vehicle or a different vehicle. An example juxtaposition or comparison will be considered in view of collected driver behavior or route history for a first vehicle with cost of ownership/operation, as well as a re-simulated cost of ownership/operation for a different vehicle. In this example, an internal combustion engine (ICE) vehicle is compared with an electric vehicle (EV).

A first route for the ICE vehicle has a fuel cost of $4.00, vehicle depreciation of $2.00, and a wear and tear cost of $1.50. A re-simulated first route for the EV indicates a fuel/electricity cost of $0.50, vehicle depreciation of $3.00, and a wear and tear cost of $2.00.

A second route for the ICE vehicle has a fuel cost of $2.00, vehicle depreciation of $1.00, and a wear and tear cost of $1.20. A re-simulated second route for the EV indicates a fuel/electricity cost of $0.30, vehicle depreciation of $1.70, and a wear and tear cost of $1.40.

These examples are indicative of a re-simulation of various routes with new estimated costs for a different vehicle and environmental costs (e.g., fuel and road surface related vehicle wear). A sum of the costs for historical routes may reflect a true and total cost of ownership of the ICE vehicle, as well as the EV vehicle.

In general, these examples relate to updating vehicle and environmental factors in the cost of routing. Vehicle depreciation (initial vehicle price and depreciation with mileage may differ with different vehicles). Also, fuel cost change over time and can be determined from online resources or crowdsourced information.

To be sure, road surfaces may degrade over time and be repaired as well, so wear on wearable parts may differ over time. When historical routes are re-simulated with an updated vehicle type and environment, the cost of those routes may be more accurate. Ultimately, a total cost of ownership may be the sum of the cost of all the routes. Re-simulating routes may avoid compression loss in cost estimates. For example, aggregating trips to a proportion of miles on the highway and on surface streets may lose important cost factors such as idling time, braking, how long the vehicle has been able to drive at highway speed on the highway, and so forth.

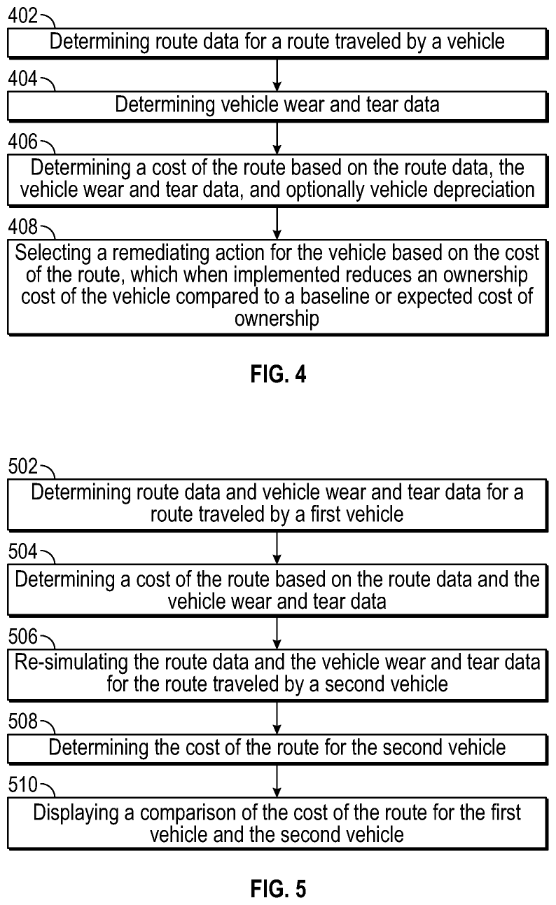

FIG. 4 is a flowchart of an example method of the present disclosure. The method can include determining how a particular route driven by a vehicle impacts its total ownership cost. That is, each time a vehicle is driven, an impact on its overall ownership cost may be realized. In some instances, a reduction in a total ownership cost can be achieved by collecting, analyzing, and remediating aspects of vehicle ownership and operation that negatively impact total ownership cost.

The method can include a step 402 of determining route data for a route traveled by a vehicle. The route data can include any one or more of road condition, traffic, fuel consumption, and trip length (can be correlated to mileage and depreciation). Other factors may also be included such as toll costs. The route data can be collected in real-time or near-real-time as the vehicle is driven, or in some instances can be analyzed prior to a trip.

The method can include a step 404 of determining vehicle wear and tear data. This can include tire wear, corrosion, suspension component wear, and so forth. It will be understood that the vehicle wear and tear data can be adjusted based on the route data. For example, rough roads can create excess tire and suspension component wear. Thus, the vehicle wear and tear data may be adjusted based on at least the road condition of the route.

Next, the method can include a step 406 of determining a cost of the route based on the route data, the vehicle wear and tear data, and optionally vehicle depreciation. That is, the route, if driven, may create a cost impact on the total ownership cost of the vehicle. If the cost negatively impacts the ownership cost of the vehicle, the method can include a step 408 of selecting a remediating action for the vehicle based on the cost of the route. It will be understood that the remediating action when implemented reduces an ownership cost of the vehicle.

In some instances, the method can include determining toll costs for the route and adding the toll costs to the cost of the route. As noted above, the method can also include determining driver behavior and adjusting the vehicle wear and tear data based on the driver behavior.

Various example remediation actions can be undertaken. One example of a remediating action can include activating a vehicle mode of operation to reduce the cost of the route. Another remediating action can include selecting an alternative route having a lower cost than the cost of the route.

In some instances, a plurality of potential routes can be calculated and compared in terms of overall cost, overall time, and impact to total vehicle ownership cost. For example, the method can include calculating a cost of each of a plurality of routes and displaying each of the plurality of routes through a navigation system.

Another example method can include steps such as determining a total ownership cost for a vehicle based on miles driven, fuel consumed, and real-time or historical vehicle component wear and tear. The method can include a step such as reducing the total ownership cost of the vehicle by implementing a remediation action, the remediation action comprising any one or more of: (i) automatic selection of routes or vehicle operating parameters by a controller of the vehicle; (ii) automatic selection of a driving mode for the vehicle; or (iii) selective adjustment of a vehicle operating parameter.

As noted above, the vehicle component wear and tear related to a road quality of roads driven by the vehicle. In some instances, the vehicle component wear and tear may be determined by comparing a baseline service life for a vehicle component. The baseline service life can be adjusted based on the quality of roads driven by the vehicle. In some configurations, the baseline service life is adjusted based on observed driver behavior.

FIG. 5 is a flowchart of another example method. The method generally relates to the comparative analysis disclosed above where the cost of ownership of a first vehicle can be compared against the cost of ownership of a second vehicle, based on analysis and re-simulation of a plurality of routes/trips.

The method can include a step 502 of determining route data and vehicle wear and tear data for a route traveled by a first vehicle. For example, historical route data for the first vehicle for one or more unique routes can be obtained. Route data and wear and tear (as well as other cost factors disclosed herein) can be determined. The method includes a step 504 of determining a cost of the route based on the route data and the vehicle wear and tear data.

Next, the method can include a step 506 of re-simulating the route data and the vehicle wear and tear data for the route traveled by a second vehicle, as well as a step 508 of determining the cost of the route for the second vehicle. In some instances, the method includes a step 510 of displaying a comparison of the cost of the route for the first vehicle and the second vehicle.

Additional costing aspects can be included. For example, the method can include steps such as determining vehicle depreciation for the route for both the first vehicle and the second vehicle. The depreciation value can be included in the cost of ownership/operation. Another aspect of route cost can include toll costs for any given route, if applicable. As noted above, vehicle wear and tear data can further include any one or more of wear to suspension wear, tire wear, brake usage, and corrosion wear, and the vehicle wear and tear data is adjusted based on at least the road condition of the route.

In some instances, the method can include selecting a remediating action for the first vehicle based on the cost of the route. The remediating action when implemented reduces an ownership cost of the first vehicle. Further, after taking the remediating action, another reanalysis of the first vehicle can be performed to determine the actual or empirical impact of the remediating action on the cost of ownership of the first vehicle. As noted above, the remediation action can include activating a vehicle mode of operation to reduce the cost of the route or selecting an alternative route having a lower cost than the cost of the route.

Another example method can include determining, for a first vehicle, a route cost for each of a plurality of historical routes based on fuel cost, wear and tear cost, and depreciation. Next, the method can include a step such as re-simulating the route cost for each of the plurality of historical routes, for a second vehicle. Next, the method can include displaying (for example through the navigation system or other human-machine interface) a comparison of the cost of the route for the first vehicle and the second vehicle that is indicative of a true and total cost of ownership of the first vehicle and the second vehicle.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching.

What is claimed is:

1. A method comprising:
determining route data for a route traveled by a vehicle, the route data comprising one or more of a road condition, traffic, fuel consumption, and/or trip length;
determining vehicle wear and tear data, the vehicle wear and tear data being adjusted based on the route data;
determining a cost of the route based on the route data, the vehicle wear and tear data, and vehicle depreciation; and
selecting a remediating action for the vehicle based on the cost of the route, wherein the remediating action when implemented reduces an ownership cost of the vehicle relative to a baseline or expected cost of ownership.

2. The method according to claim 1, further comprising determining toll costs for the route and adding the toll costs to the cost of the route.

3. The method according to claim 1, wherein the vehicle wear and tear data comprises one or more of wear to suspension wear, tire wear, brake wear, and/or corrosion wear.

4. The method according to claim 1, wherein the vehicle wear and tear data is adjusted based on the road condition of the route.

5. The method according to claim 1, further comprising determining a cost of cellular data for the route and including the cost of the cellular data in the cost of the route, the cost of the cellular data being related to an availability of cellular service along the route.

6. The method according to claim 1, wherein the remediation action comprises activating a vehicle mode of operation to reduce the cost of the route.

7. The method according to claim 1, wherein the remediation action comprises selecting an alternative route having a lower cost than the cost of the route.

8. The method according to claim 1, further comprising, for each of a plurality of routes, calculating the cost of the route, and displaying each of the plurality of routes through a navigation system.

9. The method according to claim 1, wherein the remediation action comprises applying a cost of ownership or operation threshold to at least one element of the vehicle wear and tear data.

10. A method comprising:
determining a total ownership cost for a vehicle based on miles driven, fuel consumed, and real-time or historical vehicle component wear and tear; and
reducing the total ownership cost of the vehicle by implementing a remediation action, the remediation action comprising one or more of:
automatically selecting routes or vehicle operating parameters by a controller of the vehicle;
automatically selecting a driving mode for the vehicle; or
selectively adjusting a vehicle operating parameter.

11. The method according to claim 10, further comprising estimating a road quality based on the real-time or historical vehicle component wear and tear of the vehicle.

12. The method according to claim 10, wherein automatically selecting routes includes excluding a road when insufficient road quality data exists for the road.

13. The method according to claim 11, wherein the real-time or historical vehicle component wear and tear is determined by comparing a baseline service life for a vehicle component, the baseline service life being adjusted based on a quality of roads driven by the vehicle, wherein the baseline service life is adjusted based on observed driver behavior.

14. The method according to claim 10, wherein the vehicle operating parameter comprises damping a throttle or braking response of the vehicle.

15. A system comprising:
a processor; and
a memory for storing instructions, the processor executes the instructions to:
determine route data for a route traveled by a vehicle, the route data comprising one or more of road condition, traffic, fuel consumption, and/or trip length;
determine vehicle wear and tear data, the vehicle wear and tear data being adjusted based on the route data;
determine a cost of the route based on the route data, the vehicle wear and tear data, and vehicle depreciation; and
select a remediating action for the vehicle based on the cost of the route, wherein the remediating action when implemented reduces an ownership cost of the vehicle compared to if the remediation action was not taken.

16. The system according to claim 15, wherein the processor is configured to determine toll costs for the route and add the toll costs to the cost of the route.

17. The system according to claim 15, wherein the vehicle wear and tear data comprises one or more of wear to suspension wear, tire wear, brake usage, and/or corrosion wear, and wherein the vehicle wear and tear data is adjusted based on a road condition of the route.

18. The system according to claim 15, wherein the processor is configured to determine driver behavior and adjust the vehicle wear and tear data based on the driver behavior by activating a vehicle mode of operation to reduce the cost of the route.

19. The system according to claim 15, wherein the processor is configured to select an alternative route having a lower cost than the cost of the route.

20. The system according to claim 15, wherein the processor is configured to selectively damp a throttle or braking response of the vehicle to reduce the ownership cost of the vehicle.
